(19) United States
(12) Patent Application Publication
(10) Pub. No.: US 2023/0386219 A1
(43) Pub. Date: Nov. 30, 2023

(54) RELIABILITY DETERMINATION DEVICE AND RELIABILITY DETERMINATION METHOD

(71) Applicant: Mitsubishi Electric Corporation, Tokyo (JP)

(72) Inventors: Takuji MORIMOTO, Tokyo (JP); Takumi SATO, Tokyo (JP)

(73) Assignee: Mitsubishi Electric Corporation, Tokyo (JP)

(21) Appl. No.: 18/231,488

(22) Filed: Aug. 8, 2023

Related U.S. Application Data
(63) Continuation of application No. PCT/JP2021/011826, filed on Mar. 23, 2021.

(51) Int. Cl. G06V 20/54; G06V 10/44

(52) U.S. Cl. CPC G06V 20/54; G06V 10/44

(57) ABSTRACT

An acquisition unit to acquire input data; an abstraction unit to generate abstraction data representing the input data in an abstract expression form on a basis of the input data acquired by the acquisition unit; a feature amount extracting unit to output a feature amount of the abstraction data by using the abstraction data generated by the abstraction unit as an input; a restoration unit to output restored abstraction data obtained by restoring the abstraction data by using the feature amount output by the feature amount extracting unit as an input; and a reliability determination unit to determine reliability of the feature amount output by the feature amount extracting unit on a basis of the abstraction data generated by the abstraction unit and the restored abstraction data output by the restoration unit are provided.

### CROSS REFERENCE TO RELATED APPLICATIONS

This application is a Continuation of PCT International Application No. PCT/JP2021/011826 filed on Mar. 23, 2021, which is hereby expressly incorporated by reference into the present application.

### TECHNICAL FIELD

The present disclosure relates to a reliability determination device and a reliability determination method for determining reliability of an inference result by a learned neural network.

### BACKGROUND ART

In recent years, research and development of a technique to which a neural network is applied have been advanced in many fields.

On the other hand, it is generally known that the correct answer rate of the neural network decreases for data (Hereinafter, it is referred to as “data outside the learning range”.) having low similarity with the learning data used for learning. Therefore, in the case of using the inference result by the neural network, it is important to determine whether or not the input data as the input of the neural network is data having high similarity (Hereinafter, the “data within the learning range”.) with the learning data. This is because it is assumed that an inference result obtained by using data not within the learning range, in other words, data outside the learning range as an input is not reliable.

Therefore, conventionally, a technique for determining whether or not input data of a neural network is data within a learning range using a learned autoencoder is known (For example, Patent Literature 1).

The autoencoder is obtained by supervised learning using the same data in the input layer and the output layer, and obtains a low-dimensional feature amount that well represents the property of the input. If the input data given to the autoencoder is data within the learning range, output data similar to the input data is obtained. Therefore, by using the autoencoder, it is possible to determine whether or not the input data is data within the learning range on the basis of the difference between the input data and the output data.

### CITATION LIST

### Patent Literature

Patent Literature 1: JP 2019-139277 A

### SUMMARY OF INVENTION

### Technical Problem

The prior art represented by the technique disclosed in Patent Literature 1 cannot cope with an infinite number of situations that can be assumed at the time of inference. For example, in a case where a neural network is caused to learn an infinite number of situations, learning data assuming an infinite number of situations that may occur at the time of inference needs to be prepared in advance. However, it is difficult to prepare learning data corresponding to an infinite number of situations that may occur at the time of inference.

In the prior art, it is not considered that an infinite number of situations may occur at the time of inference. Therefore, in the prior art, there is a problem that the difference between the input data and the learning data is a difference caused by the fact that it is difficult to prepare the learning data assuming an infinite number of situations, and even if the difference is a difference that does not affect the inference result, there is a possibility that the input data is determined to be data outside the learning range, in other words, the inference result of the neural network is determined to be not reliable.

The present disclosure has been made to solve the above-described problems, and an object of the present disclosure is to provide a reliability determination device capable of determining the reliability of an inference result of a neural network in consideration of a fact that an infinite number of situations may occur at the time of inference.

### Solution to Problem

A reliability determination device according to the present disclosure includes: processing circuitry performing a process: to acquire input data;
to generate abstraction data representing the input data in an abstract expression form on a basis of the input data acquired; to output a feature amount of the abstraction data by using the abstraction data generated as an input; to output restored abstraction data obtained by restoring the abstraction data by using the feature amount output as an input; and to determine reliability of the feature amount output on a basis of the abstraction data generated and the restored abstraction data output.

### Advantageous Effects of Invention

According to the present disclosure, it is possible to determine the reliability of the inference result of the neural network in consideration of the fact that an infinite number of situations may occur at the time of inference.

### BRIEF DESCRIPTION OF DRAWINGS

FIG. 1 is a diagram illustrating a configuration example of a reliability determination device according to a first embodiment.

FIGS. 2A and 2B are diagrams for explaining an example of an abstraction image indicated by abstraction image data generated by an abstraction unit in the first embodiment, in which FIG. 2A is a diagram illustrating an example of an actual environment from which the abstraction unit generates the abstraction image data, and FIG. 2B is a diagram illustrating an example of an abstraction image indicated by the abstraction image data generated by the abstraction unit in a case where the actual environment is an environment as illustrated in FIG. 2A.

FIGS. 3A, 3B, and 3C are diagrams for explaining another example of an abstraction image indicated by abstraction image data generated by the abstraction unit in the first embodiment.

FIGS. 4A and 4B are diagrams for explaining another example of an abstraction image indicated by abstraction image data generated by the abstraction unit in the first embodiment, in which FIG. 4A is a diagram illustrating an example of an actual environment from which the abstraction unit generates abstraction image data obtained by simplifying a road environment, and FIG. 4B is a diagram illustrating an example of an abstraction image indicated by abstraction image data generated by the abstraction unit in a case where the actual environment is an environment as illustrated in FIG. 4A.

FIG. 5 is a diagram for explaining an example of an abstraction image indicated by abstraction image data reflecting a future environment generated by the abstraction unit in the first embodiment.

FIG. 6 is a diagram for explaining an example of an abstraction image indicated by abstraction image data masked when a reliability determination unit determines reliability of a feature amount in the first embodiment.

FIG. 7 is a flowchart for explaining an operation of the reliability determination device according to the first embodiment.

FIGS. 8A and 8B are diagrams illustrating an example of a hardware configuration of the reliability determination device according to the first embodiment.

### DESCRIPTION OF EMBODIMENTS

Hereinafter, an embodiment of the present disclosure will be described in detail with reference to the drawings.

### First Embodiment

The reliability determination device performs inference based on input data using a learned neural network, and determines a degree (Hereinafter referred to as “reliability”.) indicating how reliable an inference result is.

More specifically, the reliability determination device acquires data regarding the situation of the reference object as input data, performs inference regarding the reference object using the learned neural network, and determines the reliability of the obtained inference result. Specifically, the data regarding the situation of the reference object includes data regarding the situation of the reference object itself or data regarding the situation around the reference object.

In the following first embodiment, as an example, it is assumed that the reliability determination device is used in a vehicle capable of autonomous driving. That is, it is assumed that the reference object is a vehicle.

The reliability determination device acquires environment data regarding an environment around the vehicle as input data, and infers a control amount in autonomous driving of the vehicle and determines reliability of the inferred control amount by using a learned neural network on the basis of the acquired environment data. In the first embodiment, the control amount of the vehicle is assumed to be, for example, a vehicle control command such as a steering wheel steering angle or a braking amount.

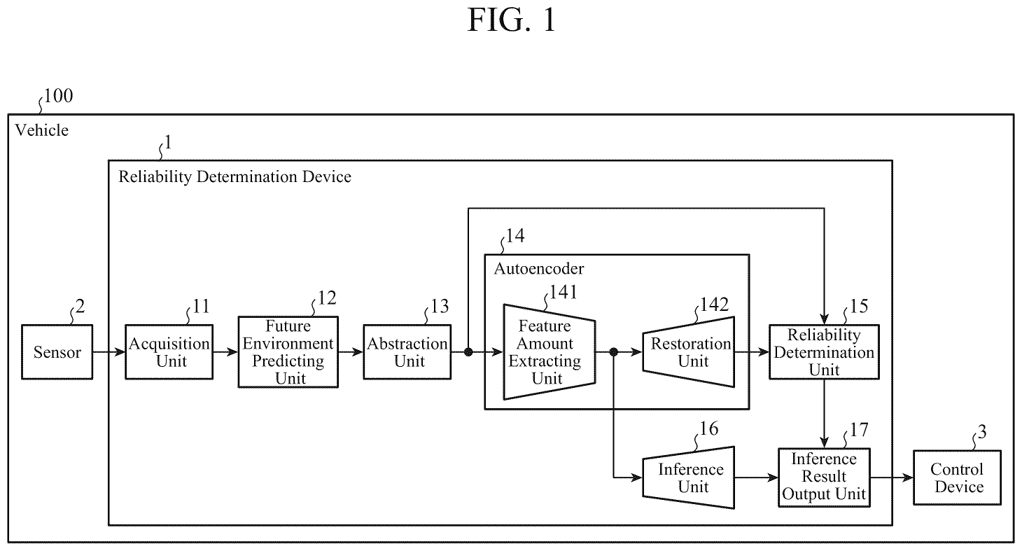

FIG. 1 is a diagram illustrating a configuration example of a reliability determination device 1 according to the first embodiment.

The reliability determination device 1 is mounted on a vehicle 100 and connected to a sensor 2 and a control device 3.

The sensor 2 is mounted on the vehicle 100 and collects data (hereinafter referred to as “environment data”) regarding the environment around the vehicle 100.

The sensor 2 is various sensors capable of collecting data on the environment around the vehicle 100, such as a GPS (not illustrated) that detects the current position of the vehicle 100, an imaging device (not illustrated) that images the periphery of the vehicle 100, a radar (not illustrated) that detects an object present around the vehicle 100, a map information acquisition device that acquires map information, a vehicle speed sensor, or an acceleration sensor. Note that, in the first embodiment, the environment around the vehicle 100 is the situation around the vehicle 100, and the situation around the vehicle 100 includes the situation of the vehicle 100.

The environment data collected by the sensor 2 includes, for example, host vehicle data, others data, terrain data, or sign data. The host vehicle data is, for example, data indicating a vehicle speed, an acceleration, a position, or a shape of the vehicle 100. The others data is, for example, data indicating the type, position, speed, or shape of an object (for example, a person, a vehicle, or an obstacle) present around the vehicle 100. The terrain data is, for example, data indicating a shape or attribute (for example, travelable or entry prohibited) of the land. The sign data is, for example, data indicating the meaning, position, or influence range of the sign.

Note that, although only one sensor 2 is illustrated in FIG. 1, this is merely an example. The reliability determination device 1 can be connected to a plurality of sensors 2. The plurality of sensors 2 may be a plurality of sensors 2 of the same type, or may be a plurality of sensors 2 of different types.

The reliability determination device 1 infers the control amount in the autonomous driving of the vehicle 100 and determines the reliability of the inferred control amount by using the learned neural network on the basis of the environment data output from the sensor 2. Details of the reliability determination device 1 will be described later.

The reliability determination device 1 outputs the inferred control amount of the vehicle 100 and information regarding the reliability of the control amount to the control device 3 in association with each other.

The control device 3 is assumed to be, for example, an autonomous driving control device that is mounted on the vehicle 100 and performs autonomous driving control of the vehicle 100.

The control device 3 performs autonomous driving control of the vehicle 100 on the basis of the control amount and the reliability output from the reliability determination device 1. For example, when the reliability is equal to or greater than a preset threshold (hereinafter, referred to as a “reliability determination threshold”), the control device 3 performs autonomous driving control using the control amount. For example, when the reliability is less than the reliability determination threshold, the control device 3 does not perform the autonomous driving control using the control amount, and performs the switching control from the autonomous driving to the manual driving.

The reliability determination device 1 includes an acquisition unit 11, a future environment predicting unit 12, an abstraction unit 13, a feature amount extracting unit 141, a restoration unit 142, a reliability determination unit 15, an inference unit 16, and an inference result output unit 17. The feature amount extracting unit 141 and the restoration unit 142 constitute an autoencoder 14.

The acquisition unit 11 acquires input data from the sensor 2.

In the first embodiment, the acquisition unit 11 acquires environment data around the vehicle 100 as input data. In the following first embodiment, the environment data around the vehicle 100 is also simply referred to as “environment data”.

The acquisition unit 11 outputs the acquired input data, in other words, the environment data, to the future environment predicting unit 12.

Note that, in the first embodiment, the acquisition unit 11 stores the acquired environment data in a storage unit (not illustrated).

The future environment predicting unit 12 predicts a future environment on the basis of the environment data acquired by the acquisition unit 11. Note that how far ahead the future environment predicting unit 12 predicts the environment can be set as appropriate.

For example, the future environment predicting unit 12 can predict the future environment from the environment data stored in the storage unit. As a specific example, for example, the future environment predicting unit 12 can predict the position and the vehicle speed of the vehicle 100 after a set time on the basis of the host vehicle data included in the environment data. Furthermore, for example, the future environment predicting unit 12 can predict the position and the moving speed of the pedestrian present around the vehicle 100 after the set time on the basis of the others data included in the environment data.

The future environment predicting unit 12 outputs data regarding the predicted future environment to the abstraction unit 13 in association with the environment data.

The abstraction unit 13 generates abstraction data indicating the input data in an abstract expression form on the basis of the input data acquired by the acquisition unit 11.

In the first embodiment, the abstraction unit 13 generates abstraction data indicating the environment data in an abstract expression form on the basis of the environment data acquired by the acquisition unit 11.

In the first embodiment, indicating data in an abstract expression form means omitting details of each part constituting the data.

The abstraction unit 13 generates, on the basis of the environment data, abstraction data indicating an object present in reality, here, for example, the vehicle 100, a road, another vehicle, or a pedestrian in a shape obtained by eliminating details of the object, for example, details such as a shape or a pattern for the vehicle 100 and the other vehicle, details such as unevenness for the road, and details such as a shape of a body for the pedestrian at the existence position. The shape in which the detail of the object is omitted is determined in advance for each object.

In the first embodiment, the abstraction data generated by the abstraction unit 13 is image data. That is, in the first embodiment, the abstraction unit 13 generates image data in which the vehicle 100, a road, another vehicle, a pedestrian, or the like present in reality is shown in a shape in which details thereof are omitted at the existence position on the image.

In the following first embodiment, image data generated as abstraction data by the abstraction unit 13 is also referred to as “abstraction image data”. In the first embodiment, the abstraction image data is, for example, data of an overhead view.

When generating the abstraction image data, the abstraction unit 13 generates the abstraction image data with reference to a reference object, here, the vehicle 100. For example, it is determined in advance at which position on the abstraction image indicated by the abstraction image data a reference object is indicated. In addition, it is determined in advance which range of environment is indicated on the abstraction image on the basis of the reference object. The abstraction unit 13 generates abstraction image data so that an object present within a predetermined range with respect to a reference object is indicated at a position corresponding to a positional relationship with the reference object on the abstraction image.

When generating the abstraction image data, the abstraction unit 13 first recognizes an object present in reality, specifically, the vehicle 100, another vehicle, a road, a pedestrian, or the like on the basis of the environment data. For example, the abstraction unit 13 may recognize an object present in reality using a known technique such as an image recognition technique or pattern matching.

Next, the abstraction unit 13 generates abstraction image data in which the recognized object is indicated in a predetermined shape at a position on an image based on a reference object, here, the vehicle 100. The abstraction unit 13 can specify a position where the vehicle 100 and an object around the vehicle 100 present in reality on the basis of the environment data. If the position where each object is present in reality can be specified, the abstraction unit 13 can specify at which position on the abstraction image data each object should be indicated.

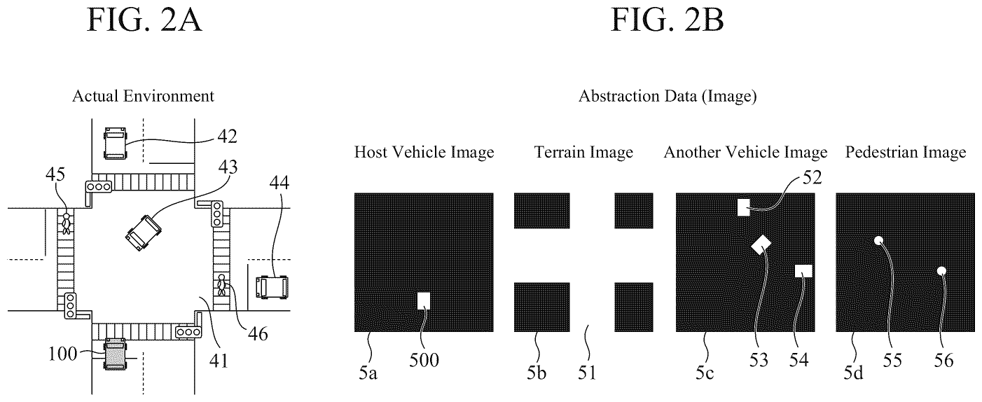

Here, FIG. 2 is a diagram for explaining an example of an abstraction image indicated by abstraction image data generated by the abstraction unit 13 in the first embodiment.

FIG. 2A is a diagram illustrating an example of an environment (hereinafter referred to as “actual environment”) around the actual vehicle 100 from which the abstraction unit 13 generates abstraction image data.

FIG. 2B is a diagram illustrating an example of an abstraction image indicated by abstraction image data generated by the abstraction unit 13 in a case where the actual environment is an environment as illustrated in FIG. 2A.

Note that FIG. 2A is an overhead view illustrating an environment around the vehicle 100. In addition, the abstraction image data generated by the abstraction unit 13 is data of an overhead view.

Now, in the actual environment as shown in FIG. 2A, the vehicle 100 is driving on a road (indicated by 41 in FIG. 2A) and arrives at an intersection, and other vehicles (indicated by 42 to 44 in FIG. 2A) are present in the intersection or at the entrance of the intersection in the traveling direction of the vehicle 100. Alternatively, around the intersection, pedestrians crossing a crosswalk (indicated by 45 to 46 in FIG. 2A) are present.

In a case where the actual environment is an environment as illustrated in FIG. 2A, the abstraction unit 13 generates, for example, abstraction image data indicating four abstraction images as illustrated in 5a to 5d of FIG. 2B.

In FIG. 2B, reference numeral 5a denotes an abstraction image representing a position of the vehicle 100, reference numeral 5b denotes an abstraction image representing a terrain of an area where the vehicle 100 can travel, that is, a lane, reference numeral 5c denotes an abstraction image representing a position of another vehicle, and reference numeral 5d denotes an abstraction image representing a position of a pedestrian.

As illustrated in FIG. 2B, in the abstraction image, the vehicle 100, the terrain of the lane, other vehicles, and pedestrians are expressed by omitting and simplifying details of each part constituting them.

For example, in the abstraction image of 5a and the abstraction image of 5c, the vehicle 100 and the other vehicles are expressed by white rectangles (See 500, 52 to 54 in FIG. 2B). Shapes and patterns of the vehicle 100 and other vehicles are omitted. Furthermore, for example, in the abstraction image of 5b, the lane is represented by a white rectangle (see 51 in FIG. 2B), and in the abstraction image of 5d, the pedestrian is represented by a white circle (55 to 56 in FIG. 2B). The unevenness of the road, the shape of the pedestrian, and the clothes of the pedestrian are omitted.

Note that, here, regarding the shape of the object expressed in the abstraction image data, the shapes of the vehicle and the road are determined to be white rectangles (see 51 of the abstraction image of 5b in FIG. 2B), and the shape of the pedestrian is determined to be a white circle (see 55 to 56 of the abstraction image of 5d in FIG. 2B) in advance. In addition, the background of the abstraction image is predetermined to be black.

Note that it is not necessary that the entire environment around the vehicle 100 is expressed on the abstraction image.

The abstraction unit 13 generates abstraction image data indicating a position of a predetermined object as an abstraction data creation target on the abstraction image on the basis of the environment data. The object to be the abstraction data creation target is, for example, an object highly related to the inference result for which the reliability determination device 1 should determine the reliability, here, an object highly related to the traveling of the vehicle 100.

Furthermore, in the description using FIGS. 2A and 2B described above, the abstraction unit 13 generates the abstraction image data for each type of object present in the environment around the vehicle 100, in other words, for each of the vehicle 100, the lane, the other vehicle, and the pedestrian, but this is merely an example. The abstraction unit 13 may generate abstraction image data indicating one abstraction image for the environment around the vehicle 100.

Furthermore, the abstraction unit 13 can also generate abstraction image data so that objects present in the environment around the vehicle 100 indicated by the abstraction image data are represented by different colors according to the types. For example, the abstraction unit 13 can also generate abstraction image data so that objects present in the environment around the vehicle 100 are represented by different colors according to the type of the object on the abstraction image, such as red for the vehicle 100 and yellow for the other vehicles.

In addition, the method of expressing an object in the abstraction image data as described with reference to FIGS. 2A and 2B is merely an example. For example, the abstraction unit 13 may generate abstraction image data so that an object present in the environment around the vehicle 100 is expressed by an expression method other than the expression method as illustrated in FIG. 2B.

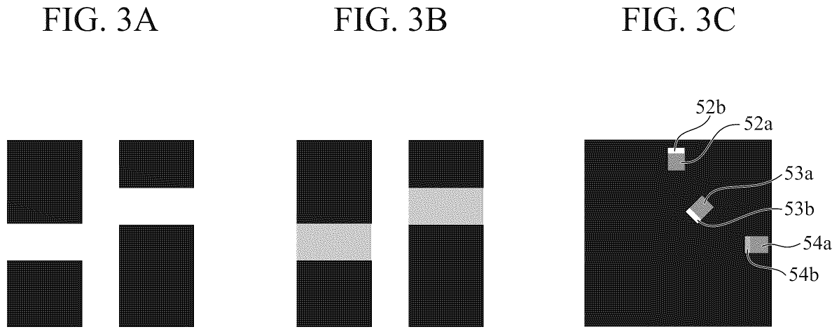

FIGS. 3A, 3B, and 3C are diagrams for explaining another example of an abstraction image indicated by abstraction image data generated by the abstraction unit 13 in the first embodiment.

Note that FIGS. 3A, 3B, and 3C illustrate an example of an abstraction image indicated by abstraction image data generated by the abstraction unit 13 in a case where the actual environment is the environment as illustrated in FIG. 2A. FIGS. 3A and 3B are examples of the abstraction image representing the terrain of the lane. FIG. 3C is an example of an abstraction image representing the positions of other vehicles.

For example, the abstraction unit 13 may generate abstraction image data indicating an area indicating a lane on which the vehicle 100 can travel and an area indicating a lane on which the vehicle 100 cannot travel by color-coding. FIG. 3A illustrates an abstraction image in a case where the abstraction unit 13 generates abstraction image data so that an area indicating a lane on which the vehicle 100 can travel is expressed by a white rectangle and an area indicating a lane on which the vehicle 100 cannot travel is expressed by a black rectangle. When the abstraction image illustrated in FIG. 3A is compared with the abstraction image indicated by 5b in FIG. 2B, it can be seen that only the lane on which the vehicle 100 can travel is expressed in white in the abstraction image illustrated in FIG. 3A. Note that the abstraction unit 13 may determine whether or not the lane is a lane on which the vehicle 100 can travel from the environment data.

Furthermore, for example, the abstraction unit 13 may generate abstraction image data to which a color indicating a speed limit is assigned for an area indicating a lane. FIG. 3B illustrates an abstraction image indicated by abstraction image data when the abstraction unit 13 generates the abstraction image data so that an area indicating a lane on which the vehicle 100 can travel is expressed by being color-coded according to the speed limit. In this example, the abstraction unit 13 expresses the level of the speed limit in white or gray. Note that the abstraction unit 13 may determine the speed limit of the lane from the environment data.

Furthermore, for example, the abstraction unit 13 may generate abstraction image data so as to express a moving direction and a moving speed of another vehicle by color-coding. For example, as illustrated in FIG. 3C, the abstraction unit 13 can generate the abstraction image data so that the other vehicle is represented by a rectangle including a dark gray rectangle (See 52a, 53a, 54a in FIG. 3C) representing the shape of the other vehicle and a light gray rectangle (See 52b, 53b, 54b in FIG. 3C) representing the moving direction of the other vehicle in the abstraction image. In the abstraction image illustrated in FIG. 3C, a light gray rectangle representing the moving direction represents that another vehicle is moving in the direction indicated by the light gray rectangle. Furthermore, the abstraction unit 13 may express a light gray rectangle representing the moving direction of another vehicle by changing the gray tone according to the moving speed. For example, in the abstraction image illustrated in FIG. 3C, it is expressed that the moving speed of the other vehicle indicated by 53a is faster than that of the other vehicle indicated by 54a. Note that the abstraction unit 13 may determine the moving direction and the moving speed of the other vehicle from the environment data.

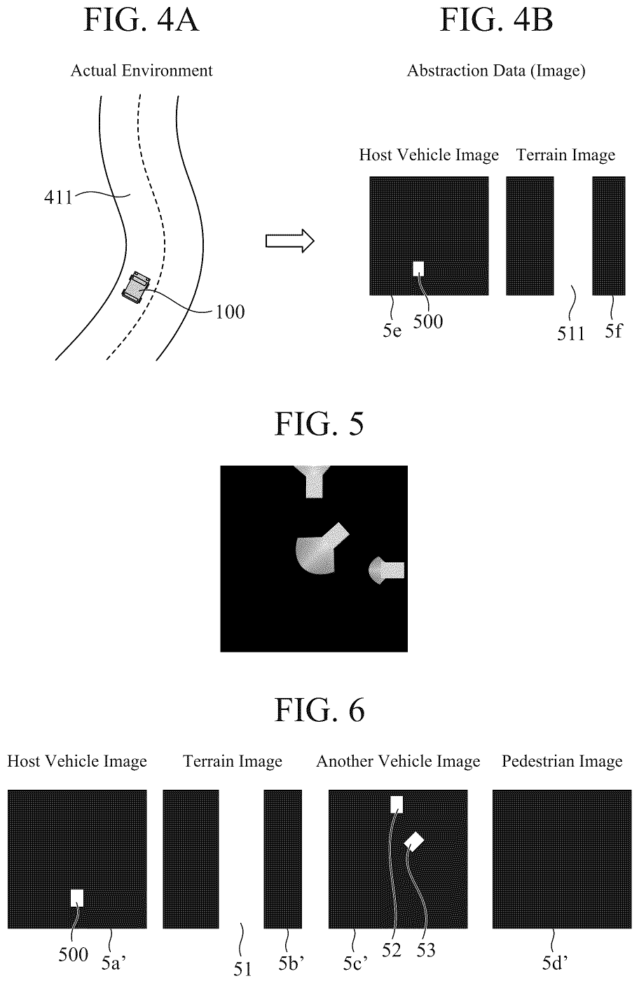

Furthermore, for example, when generating the abstraction image data, the abstraction unit 13 can also simplify the road environment of the actual environment as illustrated in FIG. 4.

FIG. 4A is a diagram illustrating an example of an actual environment from which the abstraction unit 13 generates abstraction image data obtained by simplifying a road environment.

FIG. 4B is a diagram illustrating an example of an abstraction image indicated by abstraction image data generated by the abstraction unit 13 in a case where the actual environment is an environment as illustrated in FIG. 4A.

Similarly to FIG. 2A, FIG. 4A is an overhead view illustrating an environment around the vehicle 100. In addition, the abstraction image data generated by the abstraction unit 13 is data of an overhead view.

In a case where the actual environment is an environment as illustrated in FIG. 4A, the abstraction unit 13 generates, for example, abstraction image data indicating two abstraction images as illustrated in 5e and 5f in FIG. 4B.

In FIG. 4B, reference numeral 5e denotes an abstraction image representing the position of the vehicle 100, and reference numeral 5f denotes an abstraction image representing the terrain of the lane.

Now, in the actual environment as illustrated in FIG. 4A, the road on which vehicle 100 is traveling (indicated by 411 in FIG. 4A) is not a straight line. In this case, for example, as in 5f, the abstraction unit 13 can also generate abstraction image data converted so as to indicate an abstraction image in which a road that is not a straight line in the actual environment is made into a rectangle by converting the road into a coordinate system with the traveling direction of the vehicle 100 as the vertical axis. In the abstraction image of 5f, the lane is represented by a white rectangle (see 511 in FIG. 4B).

Note that 5e is an abstraction image in which the vehicle 100 is represented by a white rectangle (see 500 in FIG. 4B), similarly to 5a in FIG. 2B.

Furthermore, for example, the abstraction unit 13 can also generate abstraction image data reflecting the future environment predicted by the future environment predicting unit 12 on the basis of the environment data acquired by the acquisition unit 11 and the data regarding the future environment predicted by the future environment predicting unit 12.

FIG. 5 is a diagram for explaining an example of an abstraction image indicated by abstraction image data reflecting a future environment generated by the abstraction unit 13 in the first embodiment.

Note that FIG. 5 is a diagram illustrating an example of an abstraction image indicated by abstraction image data generated by the abstraction unit 13 in a case where the actual environment is an environment as illustrated in FIG. 2A. FIG. 5 is an example of an abstraction image representing the position of another vehicle.

For example, as illustrated in FIG. 5, the abstraction unit 13 can generate the abstraction image data so that an area having a higher probability that another vehicle will be present in the future is expressed in a color closer to white in the abstraction image on the basis of the data regarding the future position of the other vehicle predicted by the future environment predicting unit 12.

For example, the abstraction unit 13 may generate abstraction image data reflecting a future environment using a so-called risk potential map that visualizes a potential traffic risk such as jumping out from a mobile object or a shielding object.

By the abstraction unit 13 generating the abstraction image data reflecting the future environment, more advanced inference can be achieved in the inference unit 16. Details of the inference unit 16 will be described later.

Furthermore, the abstraction unit 13 can not only generate abstraction image data reflecting a future environment but also generate abstraction image data reflecting a past environment around the vehicle 100. The abstraction unit 13 may determine the past environment around the vehicle 100 from, for example, environment data stored in the storage unit.

Furthermore, the abstraction unit 13 can also generate time-series abstraction image data indicating the environment around the vehicle 100 from the past to the future on the basis of the environment data acquired by the acquisition unit 11 and the data regarding the future environment predicted by the future environment predicting unit 12. For example, the abstraction unit 13 generates abstraction image data at a certain time point in the past (t=0), the present (t=1), and a certain time point in the future (t=2). Note that the abstraction unit 13 may generate abstraction image data indicating one abstraction image at a certain time in the past, at the present, and at a certain time in the future, or may generate abstraction image data indicating a plurality of abstraction images for each type of an object present in the environment around the vehicle 100.

As described above, the abstraction unit 13 can generate the abstraction image data on the basis of the future environment or the past environment around the vehicle 100. However, this is not essential.

In a case where the abstraction unit 13 does not have a function of generating abstraction image data reflecting a future environment, the reliability determination device 1 can be configured not to include the future environment predicting unit 12. Note that even in a case where the abstraction unit 13 generates abstraction image data reflecting a future environment, the abstraction unit 13 generates the abstraction image data using the risk potential map, and in a case where data regarding the future environment predicted by the future environment predicting unit 12 is not used, the reliability determination device 1 can be configured not to include the future environment predicting unit 12.

The abstraction unit 13 outputs the generated abstraction image data to the feature amount extracting unit 141 and the reliability determination unit 15.

The feature amount extracting unit 141 is a learned neural network that outputs a feature amount using the abstraction data output from the abstraction unit 13, here, the abstraction image data, as an input. The feature amount extracting unit 141 uses the abstraction image data as an input, extracts a feature amount indicating an essential feature of the abstraction image data, and outputs the feature amount.

The restoration unit 142 is a learned neural network that outputs data (Hereinafter, it is referred to as “restored abstraction data”.) obtained by restoring the abstraction data generated by the abstraction unit 13 using the feature amount output from the feature amount extracting unit 141 as an input. Specifically, in the first embodiment, the restoration unit 142 outputs restored image data (Hereinafter, it is referred to as “restored abstraction image data”.) obtained by restoring the abstraction image data generated by the abstraction unit 13 using the feature amount output from the feature amount extracting unit 141 as an input.

The feature amount extracting unit 141 includes an encoding unit (encoder) in the learned autoencoder 14, and the restoration unit 142 includes a composite unit (decoder) in the autoencoder 14.

The autoencoder 14 performs learning using the same data for input and output, thereby outputting data for reproducing the input data and obtaining a low-dimensional feature amount that well represents the property of the input.

In the first embodiment, the reliability determination device 1 uses the encoding unit of the learned autoencoder 14 as the feature amount extracting unit 141, and uses the composite unit of the learned autoencoder 14 as the restoration unit 142. Note that the reliability determination device 1 only needs to use an autoencoder for the feature amount extracting unit 141 and the restoration unit 142, and the type of the autoencoder used by the reliability determination device 1 as the feature amount extracting unit 141 and the restoration unit 142 is not limited. For example, the reliability determination device 1 may use a variational autoencoder as the feature amount extracting unit 141 and the restoration unit 142.

The reliability determination unit 15 determines the reliability of the feature amount extracted by the feature amount extracting unit 141 on the basis of the abstraction data generated by the abstraction unit 13 and the restored abstraction data output by the restoration unit 142. Specifically, in the first embodiment, the reliability determination unit 15 determines the reliability of the feature amount extracted from the abstraction image data by the feature amount extracting unit 141 on the basis of the abstraction image data generated by the abstraction unit 13 and the restored abstraction image data output by the restoration unit 142.

For example, the reliability determination unit 15 determines the reliability of the feature amount extracted by the feature amount extracting unit 141 on the basis of the similarity between the abstraction image data generated by the abstraction unit 13 and the restored abstraction image data output by the restoration unit 142.

Specifically, for example, the reliability determination unit 15 calculates a distance (For example, Euclidean distance) between images of an abstraction image based on the restored abstraction image data (Hereinafter, it is referred to as a “restored abstraction image”.) and an abstraction image based on the abstraction data, and sets a reciprocal of the calculated distance between the images as the similarity.

Then, the reliability determination unit 15 determines that the smaller the similarity, the lower the reliability of the feature amount. In a case where the calculated distance between the images is large, in other words, in a case where the similarity is small, it can be said that the restored abstraction image data is not accurately restored from the abstraction image data. That is, it can be said that the autoencoder 14 has not learned to extract an appropriate feature amount for restoring the abstraction image data. That is, it is considered that the learning data corresponding to the abstraction image data is not the learning target when the autoencoder 14 performs the machine learning. In general, a neural network in machine learning cannot guarantee an output for unknown data that is not a learning target when machine learning is performed.

Therefore, in a case where the calculated distance between the images is large, in other words, in a case where the similarity is small, the reliability determination unit 15 determines that the reliability of the feature amount is low.

On the other hand, the reliability determination unit 15 determines that the larger the similarity, the higher the reliability of the feature amount. In a case where the calculated distance between the images is small, in other words, in a case where the similarity is large, it can be said that the restored abstraction image data is accurately restored from the abstraction image data. That is, it can be said that the autoencoder 14 has learned to extract an appropriate feature amount for restoring the abstraction image data.

Therefore, the reliability determination unit 15 can determine that the reliability of the feature amount is high in a case where the calculated distance between the images is small, in other words, in a case w % here the similarity is large.

The reliability determination unit 15 determines whether the reliability of the feature amount is high or low by, for example, comparing the similarity with a preset threshold (Hereinafter referred to as a “similarity determination threshold”.). For example, the reliability determination unit 15 determines that the reliability of the feature amount is high when the similarity is equal to or greater than the similarity determination threshold. On the other hand, the reliability determination unit 15 determines that the reliability of the feature amount is low when the similarity is less than the similarity determination threshold.

On the basis of the abstraction image data and the restored abstraction image data, the reliability determination unit 15 may calculate a restoration error for each object present in the environment around the vehicle 100, such as another vehicle or a pedestrian, by a difference in the barycentric position or Intersection over Union (IoU), and may set a reciprocal of the calculated restoration error as the similarity. For example, the reliability determination unit 15 determines that the reliability of the feature amount is high when the similarity for each object is equal to or greater than the similarity determination threshold, and determines that the reliability of the feature amount is low when any one of the similarity for each object is less than the similarity determination threshold.

Furthermore, the reliability determination unit 15 may determine the reliability of the feature amount extracted by the feature amount extracting unit 141 on the basis of, for example, partial similarity between the abstraction image data and the restored abstraction image data.

Specifically, the reliability determination unit 15 masks an area not used for determination of the reliability of the feature amount among areas of the object present in the environment around the vehicle 100 expressed by the abstraction image indicated by the abstraction image data and the restored abstraction image indicated by the restored abstraction image data. When calculating the similarity between the abstraction image data and the restored abstraction image data, the reliability determination unit 15 calculates the similarity of the portion not masked, and determines the reliability of the feature amount extracted by the feature amount extracting unit 141 by comparing the calculated similarity with the similarity determination threshold.

The area not used for determination of the reliability of the feature amount is, for example, an area indicating an object assumed not to affect the inference of the control amount of the vehicle 100 by the inference unit 16, and the area is set in advance. Details of the inference unit 16 will be described later.

Here, FIG. 6 is a diagram for explaining an example of an abstraction image indicated by abstraction image data masked when the reliability determination unit 15 determines the reliability of the feature amount in the first embodiment.

FIG. 6 illustrates, as an example, an image of an abstraction image after the reliability determination unit 15 masks a region not used for determination of the reliability of the feature amount with respect to the abstraction image (5a in FIG. 2B) representing the position of the vehicle 100 illustrated in FIG. 2B, the abstraction image (5b in FIG. 2B) representing the area where the vehicle 100 can travel, that is, the terrain of the lane, the abstraction image (5c in FIG. 2B) representing the position of another vehicle, and the abstraction image (5d in FIG. 2B) representing the position of the pedestrian.

Note that 5a′ in FIG. 6 indicates an image of the abstraction image after masking the abstraction image indicated by 5a in FIG. 2B. 5b′ in FIG. 6 indicates an image of the abstraction image after masking the abstraction image indicated by 5b in FIG. 2B. 5c′ in FIG. 6 indicates an image of the abstraction image after masking the abstraction image indicated by 5c in FIG. 2B. 5d′ in FIG. 6, indicates an image of the abstraction image after masking the abstraction image indicated by 5d in FIG. 2B.

For example, in an actual environment (see FIG. 2A), it is assumed that a signal installed on a road orthogonal to a road on which the vehicle 100 travels is a red signal. In this case, the situation of the road orthogonal to the road on which the vehicle 100 travels has a small influence on the travel of the vehicle 100. That is, the influence of the situation of the road orthogonal to the road on which the vehicle 100 travels on the control amount of the vehicle 100 is small. Therefore, the reliability determination unit 15 masks an area expressing a situation of a road orthogonal to a road on which the vehicle 100 travels, specifically, a lane orthogonal to a lane on which the vehicle 100 is traveling, another vehicle traveling on the road, and a pedestrian crossing a crosswalk of the road. Note that the reliability determination unit 15 can determine the red signal on the basis of the environment data.

As a result, a mask is applied to an area of the lane orthogonal to the lane on which the vehicle 100 is traveling in the terrain of the lane represented by 5b in FIG. 2B (see 5b′ in FIG. 6). Further, a mask is applied to an area indicated by 54 where another vehicle is located among other vehicles indicated by 5c in FIG. 2B (see 5c′ in FIG. 6). Further, all portions of the area where the pedestrians are located represented by 5d in FIG. 2B are masked (see 5d′ in FIG. 6).

Note that, in FIG. 6, an example has been described in which the reliability determination unit 15 masks the abstraction image data, but the reliability determination unit 15 also masks the restored abstraction image data by a similar method.

Furthermore, for example, the reliability determination unit 15 may determine the reliability after weighting the similarity between the abstraction data generated by the abstraction unit 13 and the restored abstraction data output by the restoration unit 142 for each type of an object present in the environment around the reference object. Specifically, in the first embodiment, for example, the reliability determination unit 15 may determine the reliability after weighting the similarity between the abstraction image data generated by the abstraction unit 13 and the restored abstraction image data output by the restoration unit 142 for each type of an object present in the environment around the vehicle 100.

In the above description, the reliability determination unit 15 expresses the reliability of the feature amount extracted by the feature amount extracting unit 141 as a discrete value such as “high” or “low”, but this is merely an example. For example, the reliability determination unit 15 may express the reliability of the feature amount extracted by the feature amount extracting unit 141 as a continuous value such as a numerical value from “0” to “1”. For example, the reliability determination unit 15 determines the reliability of the feature amount according to the similarity between the abstraction image data and the restored abstraction image data. For example, the degree of similarity and the degree of reliability to be determined are determined in advance.

The reliability determination unit 15 outputs information regarding the determined reliability to the inference result output unit 17.

The inference unit 16 is a learned neural network that outputs an inference result using the feature amount output by the feature amount extracting unit 141 as an input.

In the first embodiment, the inference unit 16 outputs the control amount of the vehicle 100 using the feature amount output by the feature amount extracting unit 141 as an input.

The inference unit 16 is any neural network. For example, the inference unit 16 is a neural network that uses, as learning data, a set of abstraction image data generated on the basis of environment data collected by a person performing test travel of the vehicle 100 and an appropriate control amount of the vehicle 100, and is learned by so-called supervised learning on the basis of the learning data. Furthermore, for example, the inference unit 16 may be a neural network that uses, as learning data, a set of abstraction image data generated on the basis of the environment data collected by the simulator and an appropriate control amount of the vehicle 100, and is learned by so-called supervised learning on the basis of the learning data.

Note that the feature amount to be an input of the inference unit 16 is a feature amount obtained by using the learned feature amount extracting unit 141 and outputting, as an input, the abstraction data output from the abstraction unit 13 by the feature amount extracting unit 141.

The inference result output unit 17 outputs the inference result and the reliability in association with each other, with the reliability determined by the reliability determination unit 15 as the reliability with respect to the inference result output by the inference unit 16 to the control device 3 on the basis of the information regarding the reliability output from the reliability determination unit 15 and the inference result output by the inference unit 16.

Specifically, in the first embodiment, the inference result output unit 17 outputs the control amount of the vehicle 100 and the reliability in association with each other, with the reliability determined by the reliability determination unit 15 as the reliability with respect to the control amount of the vehicle 100 output by the inference unit 16 to the control device 3 on the basis of the information regarding the reliability output from the reliability determination unit 15 and the control amount of the vehicle 100 output by the inference unit 16.

As described above, the reliability determined by the reliability determination unit 15 is the reliability with respect to the feature amount extracted from the abstraction data. In addition, the inference unit 16 infers the control amount of the vehicle 100 using the feature amount extracted from the abstraction data as an input.

Therefore, for example, in a case where the reliability of the feature amount is low, it can be said that the control amount of the vehicle 100 obtained using the feature amount with the low reliability as an input is also not reliable. On the other hand, for example, in a case where the reliability of the feature amount is high, it can be said that the control amount of the vehicle 100 obtained using the feature amount with the high reliability as an input is also reliable.

An operation of the reliability determination device 1 according to the first embodiment will be described.

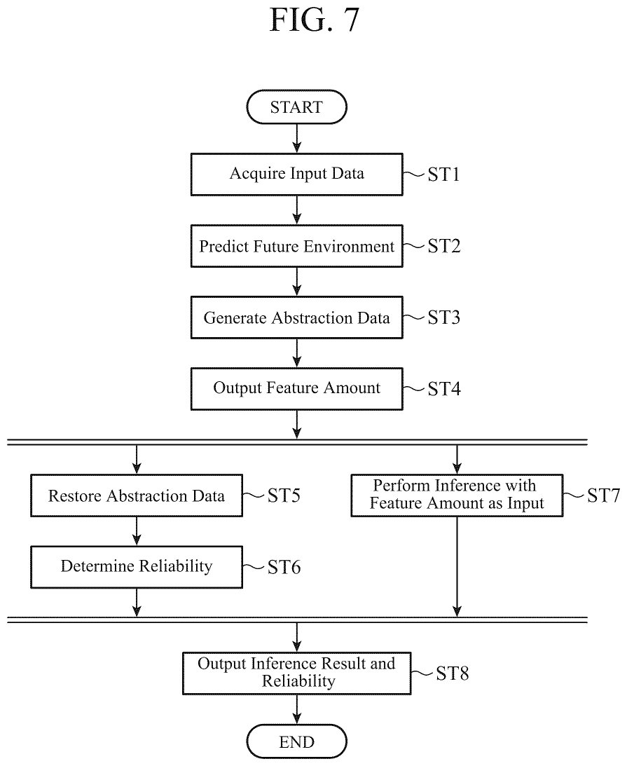

FIG. 7 is a flowchart for explaining the operation of the reliability determination device 1 according to the first embodiment.

For example, during the autonomous driving of the vehicle 100, the operation described in the flowchart of FIG. 7 is repeated.

The acquisition unit 11 acquires input data from the sensor 2 (step ST1).

Specifically, the acquisition unit 11 acquires environment data as input data.

The acquisition unit 11 outputs the acquired input data, in other words, the environment data, to the future environment predicting unit 12.

In addition, the acquisition unit 11 stores the acquired environment data in the storage unit.

The future environment predicting unit 12 predicts a future environment on the basis of the environment data acquired by the acquisition unit 11 in step ST1 (step ST2).

The future environment predicting unit 12 outputs data regarding the predicted future environment to the abstraction unit 13 in association with the environment data.

The abstraction unit 13 generates abstraction data indicating the input data in an abstract expression form on the basis of the input data acquired by the acquisition unit 11 in step ST1 (step ST3).

Specifically, the abstraction unit 13 generates abstraction image data indicating the environment data in an abstract expression form on the basis of the environment data acquired by the acquisition unit 11 in step ST1.

For example, the abstraction unit 13 may generate abstraction image data reflecting the future environment predicted by the future environment predicting unit 12 on the basis of the environment data acquired by the acquisition unit 11 in step ST1 and the data regarding the future environment predicted by the future environment predicting unit 12 in step ST2. Furthermore, the abstraction unit 13 may generate abstraction image data reflecting the past environment around the vehicle 100.

Furthermore, the abstraction unit 13 may generate time-series abstraction image data indicating the environment around the vehicle 100 from the past to the future on the basis of the environment data acquired by the acquisition unit 11 in step ST1 and the data regarding the future environment predicted by the future environment predicting unit 12 in step ST2.

The abstraction unit 13 outputs the generated abstraction image data to the feature amount extracting unit 141 and the reliability determination unit 15.

Note that, in a case where the abstraction unit 13 does not have a function of generating the abstraction image data on the basis of the future environment, the operation of the reliability determination device 1 can omit step ST2.

The feature amount extracting unit 141 uses the abstraction image data output from the abstraction unit 13 in step ST3 as an input to extract and output a feature amount indicating an essential feature of the abstraction image data (step ST4).

The restoration unit 142 outputs restored abstraction image data obtained by restoring the abstraction image data generated by the abstraction unit 13 in step ST3 by using the feature amount output from the feature amount extracting unit 141 in step ST4 as an input (step ST5).

On the basis of the abstraction image data generated by the abstraction unit 13 in step ST3 and the restored abstraction image data output by the restoration unit 142 in step ST5, the reliability determination unit 15 determines the reliability of the feature amount extracted by the feature amount extracting unit 141 from the abstraction image data in step ST4 (step ST6).

The reliability determination unit 15 outputs information regarding the determined reliability to the inference result output unit 17.

The inference unit 16 outputs the control amount of the vehicle 100 using the feature amount output by the feature amount extracting unit 141 in step ST4 as an input (step ST7).

The inference result output unit 17 outputs the control amount of the vehicle 100 and the reliability in association with each other to the control device 3, with the reliability determined by the reliability determination unit 15 as the reliability with respect to the control amount of the vehicle 100 output by the inference unit 16, on the basis of the information regarding the reliability output from the reliability determination unit 15 in step ST6 and the control amount of the vehicle 100 output by the inference unit 16 in step ST7 (step ST8).

As described above, the reliability determination device 1 generates the abstraction data indicating the environment data in the abstract expression form, in other words, the abstraction image data on the basis of the acquired input data, in other words, the environment data. The reliability determination device 1 obtains the feature amount of the abstraction image data using a neural network (feature amount extracting unit 141) that outputs the feature amount of the abstraction image data using the generated abstraction image data as an input, and obtains the restored abstraction image data using a neural network (restoration unit 142) that outputs the restored abstraction image data obtained by restoring the abstraction image data using the feature amount as an input. Then, the reliability determination device 1 determines the reliability of the feature amount obtained from the abstraction image data on the basis of the abstraction image data and the restored abstraction image data.

As described above, in recent years, research and development of a technique to which a neural network is applied have been advanced in many fields. For example, a technique for implementing autonomous driving by learning, with a neural network, a set of data regarding an environment such as an image captured by a camera and an appropriate driving behavior in the environment has been developed.

On the other hand, in the neural network, the correct answer rate generally decreases for data outside the learning range.

Therefore, as described above, conventionally, a technique for determining whether or not input data of a neural network is data within a learning range using a learned autoencoder is known.

However, the prior art cannot cope with an infinite number of situations that can be assumed at the time of inference.

For example, in the technology for implementing autonomous driving as described above, there are an infinite number of situations around a vehicle that performs autonomous driving, such as a road shape, a shape of a surrounding vehicle, or clothes of a pedestrian. On the other hand, it is difficult to prepare learning data covering all situations as learning data of the neural network. Then, in the prior art, the difference between the input data and the learning data is a difference caused by difficulty in preparing learning data assuming an infinite number of situations, and even if the difference is a difference that does not affect the inference result, there is a possibility that the input data is determined to be data outside the learning range.

In the technology for implementing the autonomous driving as described above, for example, only the clothes of the pedestrian in the learning data and the clothes of the pedestrian in the actual situation at the time of inference are different, and there is a possibility that the input data at the time of inference is determined to be outside the learning range.

In addition, since a large amount of learning data is required for learning of the neural network, learning data for learning of the neural network may be generated by a simulator. However, the learning data generated by the simulator does not include, for example, information specific to the actual environment. Therefore, in the prior art, there is a possibility that the determination accuracy of whether or not the input data is data within the learning range, in other words, the determination accuracy of the inference result of the neural network decreases.

On the other hand, the reliability determination device 1 according to the first embodiment does not input the input data as it is to the autoencoder (feature amount extracting unit 141) and determines whether or not the input data is data within the learning range, that is, whether or not the feature amount is sufficient to be reliable, but generates the abstraction data on the basis of the input data and inputs the abstraction data to the autoencoder and determines whether or not the feature amount extracted from the abstraction data is sufficient to be reliable. Then, the reliability determination device 1 determines whether or not the inference result of the neural network (the inference unit 16) is sufficient to be reliable by determining whether or not the feature amount is sufficient to be reliable.

Since the abstraction data is data in which details of each part constituting the input data are omitted, for example, the reliability determination device 1 does not determine that the feature amount extracted from the input data, more specifically, the abstraction data is not sufficient to be reliable only because the clothing of the pedestrian in the learning data is different from the clothing of the pedestrian in the actual situation at the time of inference. That is, for example, the reliability determination device 1 does not determine that the inference result of the neural network (the inference unit 16) is not sufficient to be reliable only because the clothing of the pedestrian in the learning data is different from the clothing of the pedestrian in the actual situation at the time of inference. As described above, the reliability determination device 1 can determine the reliability of the inference result of the neural network in consideration of the fact that an infinite number of situations may occur at the time of inference.

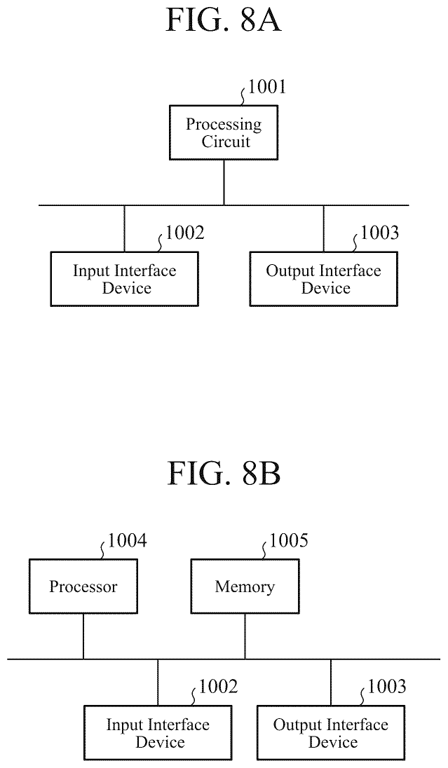

FIGS. 8A and 8B are diagrams illustrating an example of a hardware configuration of the reliability determination device 1 according to the first embodiment.

In the first embodiment, the functions of the acquisition unit 11, the future environment predicting unit 12, the abstraction unit 13, the reliability determination unit 15, and the inference result output unit 17 are implemented by a processing circuit 1001. That is, the reliability determination device 1 includes the processing circuit 1001 for acquiring the feature amount from the abstraction image data generated on the basis of the environment data regarding the environment around the vehicle 100 and performing control to determine the reliability of the control amount of the vehicle 100 which is the inference result inferred using the feature amount as an input.

The processing circuit 1001 may be dedicated hardware as illustrated in FIG. 8A or a processor 1004 that executes a program stored in a memory as illustrated in FIG. 8B.

In a case where the processing circuit 1001 is dedicated hardware, the processing circuit 1001 corresponds to, for example, a single circuit, a composite circuit, a programmed processor, a parallel programmed processor, an application specific integrated circuit (ASIC), a field-programmable gate array (FPGA), or a combination thereof.

In a case where the processing circuit is the processor 1004, the functions of the acquisition unit 11, the future environment predicting unit 12, the abstraction unit 13, the reliability determination unit 15, and the inference result output unit 17 are implemented by software, firmware, or a combination of software and firmware. Software or firmware is written as a program and stored in a memory 1005. The processor 1004 reads and executes the program stored in the memory 1005, thereby executing the functions of the acquisition unit 11, the future environment predicting unit 12, the abstraction unit 13, the reliability determination unit 15, and the inference result output unit 17. That is, the reliability determination device 1 includes the memory 1005 for storing a program that results in execution of steps ST1 to ST8 of FIG. 7 described above when executed by the processor 1004. In addition, it can also be said that the program stored in the memory 1005 causes a computer to execute a processing procedure or method of the acquisition unit 11, the future environment predicting unit 12, the abstraction unit 13, the reliability determination unit 15, and the inference result output unit 17. Here, the memory 1005 corresponds to, for example, a nonvolatile or volatile semiconductor memory such as a RAM, a read only memory (ROM), a flash memory, an erasable programmable read only memory (EPROM), or an electrically erasable programmable read-only memory (EEPROM), or a magnetic disk, a flexible disk, an optical disk, a compact disc, a mini disc, a digital versatile disc (DVD), or the like.

Note that a part of the functions of the acquisition unit 11, the future environment predicting unit 12, the abstraction unit 13, the reliability determination unit 15, and the inference result output unit 17 may be implemented by dedicated hardware, and a part thereof may be implemented by software or firmware. For example, the functions of the acquisition unit 11 and the inference result output unit 17 can be implemented by the processing circuit 1001 as dedicated hardware, and the functions of the acquisition unit 11, the future environment predicting unit 12, the abstraction unit 13, the reliability determination unit 15, and the inference result output unit 17 can be implemented by the processor 1004 reading and executing programs stored in the memory 1005.

Further, the reliability determination device 1 includes an input interface device 1002 and an output interface device 1003 that perform wired communication or wireless communication with a device such as the sensor 2 or the control device 3.

In the first embodiment described above, the reliability determination device 1 is an in-vehicle device mounted on the vehicle 100, and the acquisition unit 11, the future environment predicting unit 12, the abstraction unit 13, the autoencoder 14, the reliability determination unit 15, the inference unit 16, and the inference result output unit 17 are included in the reliability determination device 1.

Alternatively, some of the acquisition unit 11, the future environment predicting unit 12, the abstraction unit 13, the autoencoder 14, the reliability determination unit 15, the inference unit 16, and the inference result output unit 17 may be included in an in-vehicle device of the vehicle 100, and the others may be included in a server connected to the in-vehicle device via a network, and the in-vehicle device and the server may constitute the reliability determination system.

In addition, in the first embodiment described above, the inference unit 16 is provided in the reliability determination device 1, but this is merely an example. The inference unit 16 may be provided outside the reliability determination device 1 in a device that can be referred to by the reliability determination device 1.

In addition, in the first embodiment described above, as an example, it is assumed that the reference object is the vehicle 100, the reliability determination device 1 is used in the vehicle 100 capable of autonomous driving, and the reliability determination device 1 determines the reliability of the inferred control amount. However, this is merely an example.

The reference object is various mobile objects such as a forklift, an unmanned carrier, an industrial robot in a factory, or an aircraft, and the reliability determination device 1 can infer control amounts for controlling the various mobile objects and also determine reliability of the inferred control amounts.

For example, in the reliability determination device 1, the input data acquired by the acquisition unit 11 can be environment data regarding the environment around the mobile object, and the abstraction data generated by the abstraction unit 13 can be image data indicating the environment around the mobile object. The feature amount extracting unit 141 outputs a feature amount with the image data as an input, the restoration unit 142 uses the feature amount output by the feature amount extracting unit 141 as an input to output restored image data obtained by restoring the image data from the feature amount, and the reliability determination unit 15 can determine the reliability on the basis of the image data and the restored image data.

Note that, in the first embodiment described above, the control device 3 is assumed to be an autonomous driving control device that performs autonomous driving control of the vehicle 100, but this is merely an example. The control device 3 may be an automatic driving control device that performs driving control of a mobile object such as a forklift, an unmanned carrier, an industrial robot, or an aircraft. The control device 3 can be a device that performs various controls on the basis of the inference result and the reliability output from the reliability determination device 1.

In addition, the inference result by the inference unit 16 is not limited to the control amount. That is, the inference result for which the reliability determination device 1 determines the reliability is not limited to the control amount. For example, the inference unit 16 can also infer the state of the occupant in the vehicle 100 from abstraction data generated on the basis of environment data regarding the environment in the vehicle 100. In this case, the inference unit 16 is a learned neural network that uses the feature amount as an input to output data (Hereinafter, referred to as “occupant state data”.) regarding the state of the occupant in the vehicle 100. The reliability determination device 1 determines the reliability of the occupant state data output by the inference unit 16 by determining the reliability of the feature amount output by the feature amount extracting unit 141 on the basis of the abstraction data on the basis of the similarity between the abstraction data and restored abstraction data restored by the restoration unit 142. Note that in the first embodiment, the mobile object includes a person.

The inference result output unit 17 of the reliability determination device 1 outputs the occupant state data and the reliability in association with each other with the reliability determined by the reliability determination unit 15 as the reliability with respect to the occupant state data output by the inference unit 16.

Furthermore, for example, the inference unit 16 can also infer the necessity of activation of a warning device in a case where there is a possibility that the vehicle 100 falls into a shortage situation from the abstraction data generated on the basis of the environment data regarding the environment around the vehicle 100 or in the vehicle 100. In this case, the inference unit 16 is a learned neural network that uses the feature amount as an input to output data regarding the necessity of activation of the warning device in a case where there is a possibility that the vehicle 100 falls into a shortage situation. The reliability determination device 1 determines, on the basis of the similarity between the abstraction data and the restored abstraction data restored by the restoration unit 142, the reliability of the feature amount output by the feature amount extracting unit 141 on the basis of the abstraction data, thereby determining the reliability of the data regarding the possibility that the vehicle 100 falls into an unexpected situation, output from the inference unit 16.

The inference result output unit 17 of the reliability determination device 1 outputs data regarding the possibility that the vehicle 100 falls into an unexpected situation and the reliability in association with each other with the reliability determined by the reliability determination unit 15 as the reliability with respect to the data regarding the possibility that the vehicle 100 falls into an unexpected situation output by the inference unit 16.

In addition, in the first embodiment, the input data is the environment data around the reference object, but this is merely an example. The input data may be data indicating the situation of the reference object itself regardless of the environment around the reference object.

For example, the input data may be animal and plant data regarding the status of animals and plants. The inference unit 16 infers the type of plants/animals from the abstraction data generated on the basis of the plant/animal data. In this case, the inference unit 16 is a learned neural network that uses the feature amount as an input to output data (Hereinafter, it is referred to as “animal/plant type data”.) regarding the type of plants/animals. The reliability determination unit 15 of the reliability determination device 1 determines the reliability of the animal/plant type data output from the inference unit 16 by determining the reliability of the feature amount output by the feature amount extracting unit 141 on the basis of the abstraction data on the basis of the similarity between the abstraction data generated from the animal/plant data and the restored abstraction data restored by the restoration unit 142. The inference result output unit 17 of the reliability determination device 1 outputs the animal/plant type data and the reliability in association with each other with the reliability determined by the reliability determination unit 15 as the reliability with respect to the animal/plant type data output by the inference unit 16.

Note that in this case, the reference object is plants/animals. As described above, the reference object may be an object other than the mobile object.

As described above, according to the first embodiment, the reliability determination device 1 is configured to include the acquisition unit 11 to acquire input data; the abstraction unit 13 to generate abstraction data representing the input data in an abstract expression form on the basis of the input data acquired by the acquisition unit 11; the feature amount extracting unit 141 to output a feature amount of the abstraction data by using the abstraction data generated by the abstraction unit 13 as an input; the restoration unit 142 to output restored abstraction data obtained by restoring the abstraction data by using the feature amount output by the feature amount extracting unit 141 as an input; and the reliability determination unit 15 to determine reliability of the feature amount output by the feature amount extracting unit 141 on the basis of the abstraction data generated by the abstraction unit 13 and the restored abstraction data output by the restoration unit 142. Therefore, the reliability determination device 1 can determine the reliability of the inference result of the neural network in consideration of the fact that an infinite number of situations may occur at the time of inference.

Furthermore, in the present disclosure, any component of the embodiment can be modified, or any component of the embodiment can be omitted.

### INDUSTRIAL APPLICABILITY

The reliability determination device according to the present disclosure can determine the reliability of the inference result of the neural network in consideration of the fact that an infinite number of situations may occur at the time of inference.

### REFERENCE SIGNS LIST

1: reliability determination device, 2: sensor, 3: control device, 11: acquisition unit, 12: future environment predicting unit, 13: abstraction unit, 14: autoencoder, 141: feature amount extracting unit, 142: restoration unit, 15: reliability determination unit, 16: inference unit, 17: inference result output unit, 100: vehicle, 1001: processing circuit, 1002: input interface device, 1003: output interface device, 1004: processor, 1005: memory

1. A reliability determination device comprising:
processing circuitry performing a process:
to acquire input data;
to generate abstraction data representing the input data in an abstract expression form on a basis of the input data acquired;
to output a feature amount of the abstraction data by using the abstraction data generated as an input;
to output restored abstraction data obtained by restoring the abstraction data by using the feature amount output as an input; and
to determine reliability of the feature amount output on a basis of the abstraction data generated and the restored abstraction data output.

2. The reliability determination device according to claim 1, wherein
the process uses an encoder in a learned autoencoder, and
the process uses a composer in the autoencoder.

3. The reliability determination device according to claim 1, wherein
the input data acquired is environment data regarding an environment,
the process further comprises to predict the future environment on a basis of the environment data acquired, and
the process generates the abstraction data on a basis of the environment data acquired and data regarding the future environment predicted.

4. The reliability determination device according to claim 1, wherein
the input data acquired is environment data regarding an environment around a mobile object,
the abstraction data generated is image data indicating the environment around the mobile object,
the process outputs the feature amount with the image data as an input,
the process receives the feature amount output as an input, and outputs the restored image data obtained by restoring the image data from the feature amount, and
the process determines the reliability on a basis of the image data and the restored image data.

5. The reliability determination device according to claim 4, the process further comprising to predict the future environment on a basis of the environment data acquired, wherein
the process generates the time-series image data indicating the environment around the mobile object from the past to the future on a basis of the environment data acquired and the future environment predicted.

6. The reliability determination device according to claim 1, the process further comprising:
to output an inference result by using the feature amount output as an input; and
to output the inference result and the reliability in association with each other, with the reliability determined as the reliability with respect to the inference result output.

7. The reliability determination device according to claim 6, wherein
the input data acquired is environment data regarding an environment around a vehicle,
the abstraction data generated is image data regarding an environment around the vehicle,
the process outputs the feature amount by using the image data as an input,
the process outputs the restored image data obtained by restoring the image data from the feature amount by using the feature amount output as an input,
the process determines the reliability on a basis of the image data and the restored image data,
the process outputs a control amount of the vehicle by using the feature amount output as an input, and
the process outputs the control amount of the vehicle and the reliability in association with each other with the reliability determined as the reliability with respect to the control amount of the vehicle output.

8. The reliability determination device according to claim 6, wherein
the input data acquired is environment data regarding an environment in a vehicle,
the process generates the abstraction data on a basis of the environment data acquired,
the process outputs occupant state data regarding a state of an occupant of the vehicle by using the feature amount output as an input, and
the process outputs the occupant state data and the reliability in association with each other with the reliability determined as the reliability with respect to the occupant state data output.

9. A reliability determination method comprising:
acquiring input data;
generating abstraction data representing the input data in an abstract expression form on a basis of the input data acquired;
outputting a feature amount of the abstraction data by using the abstraction data generated as an input;
outputting restored abstraction data obtained by restoring the abstraction data by using the feature amount output as an input; and
determining reliability of the feature amount output on a basis of the abstraction data generated and the restored abstraction data output.
